(19) United States
(12) Patent Application Publication
(10) Pub. No.: US 2004/0189435 A1
(43) Pub. Date: Sep. 30, 2004

(54) Decorative lighting with safety protecting circuit

(76) Inventor: Jin Wu, Huizhou City (CN)

Correspondence Address: RABIN & BERDO, P.C., Suite 500, 1101 14th Street, N.W., Washington, DC, 20005, US

(21) Appl. No.: 10/614,035

(22) Filed: Jul. 8, 2003

(30) Foreign Application Priority Data
Mar. 26, 2003 (CN) 03224514.9

(51) Int. Cl. H01H 85/04

(52) U.S. Cl. 337/167

(57) ABSTRACT

This invention is related to a decorative lighting with the safety protecting circuit, which is composed of a main circuit, a branch circuit connected to it and a lighting installed in the branch circuit. The said self-restoring protecting device is installed in the branch circuit of the lighting. The said self-restoring protecting device is a self-mending fuse, which is aPPTCpolymerself-mending fuse. The said self-restoring protecting device is a bimetallic fuse. A self-mending fuse is installed in the circuit of the lighting. When the circuit is overloaded or short circuit occurs, the self-mending fuse used will have high resistance, breaking and thus protecting the circuit. Upon removal of the trouble, the self-mending fuse will automatically restore to the conductive state. Therefore the self-mending fuse, once installed, can be used repeatedly, conveniently and safely.

### FIELD OF THE INVENTION

This invention is related to a decorative lighting or, more precisely, the technique of improving the safety protecting circuit of the lighting.

### BACKGROUND OF THE INVENTION

At present, people normally use disposable fuses as overcurrent-protecting elements like metallic tin wires of low melting point in the safety protecting circuits in the lighting industry. However, as such disposable fuses have to be promptly replaced after being blown out, it is inconvenient in use and unsafe in operation. Nowadays, for the purpose of enhancing the effect, many decorative lighting are often connected in series or in parallel to present great varieties. Therefore, in the lighting industry, higher requirements have been brought forward in the field of the safety protecting circuit.

### SUMMARY OF THE INVENTION

The objective of this invention is to provide a kind of decorative lighting that has good safety protecting property and is convenient in use.

This invention fulfils the inventive objective through the following technical solution.

The decorative lighting with the safety protecting circuit is composed of a main circuit, a branch circuit connected to it and a lighting installed in the branch circuit. It features that there is a self-restoring protecting device installed in the circuit of the lamp adornment.

The said self-restoring protecting device is installed in the main circuit of the lighting.

The said self-restoring protecting device is installed in the branch circuit of the lighting.

The said self-restoring protecting device is a self-mending fuse.

The said self-mending fuse is a PPTC polymer self-mending fuse.

The said self-restoring protecting device is a bimetallic fuse.

The said decorative lighting is the Christmas lighting or that for celebrating festivals.

The invention has the following advantages in comparison with existing techniques.

A self-mending fuse is installed in the circuit of the lighting. When the circuit is overloaded or short circuit occurs, the self-mending fuse will have high resistance, breaking the circuit and therefore, protecting the load. Upon removal of the trouble the self-mending fuse will automatically restore to the conductive state. Therefore once the self-mending fuse is installed, it can be used repeatedly, conveniently and safely.

### BRIEF DESCRIPTION OF THE DRAWINGS

FIG. 1 is the schematic diagram showing the structure of the invention with the self-mending fuse installed in the main circuit of a line of lighting connected in series.

FIG. 2 is the schematic diagram showing the structure of the invention with the self-mending fuse installed in the main circuit of multiple lines of lighting connected both in series and in parallel.

FIG. 3 is the schematic diagrams showing the structure of this invention with the self-mending fuse installed in the main circuit of multiple lines of lighting connected both in series and in parallel and controlled by IC controller.

FIG. 4 is the schematic diagram of the structure of this invention with self-mending fuse installed in the branch circuit of multiple lighting connected both in series and in parallel.

### DETAIL DESCRIPTION OF THE INVENTION

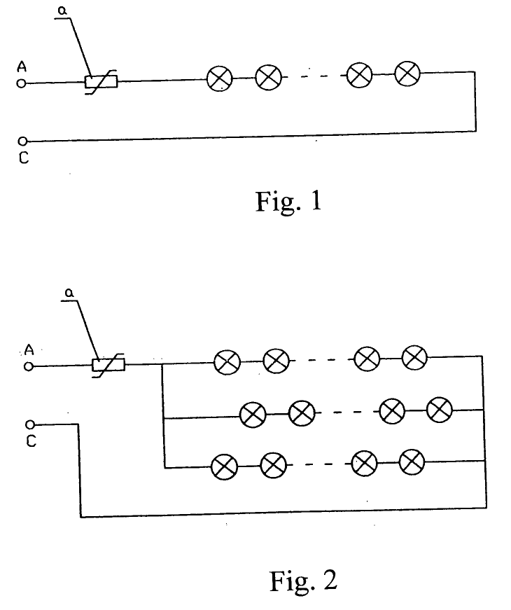

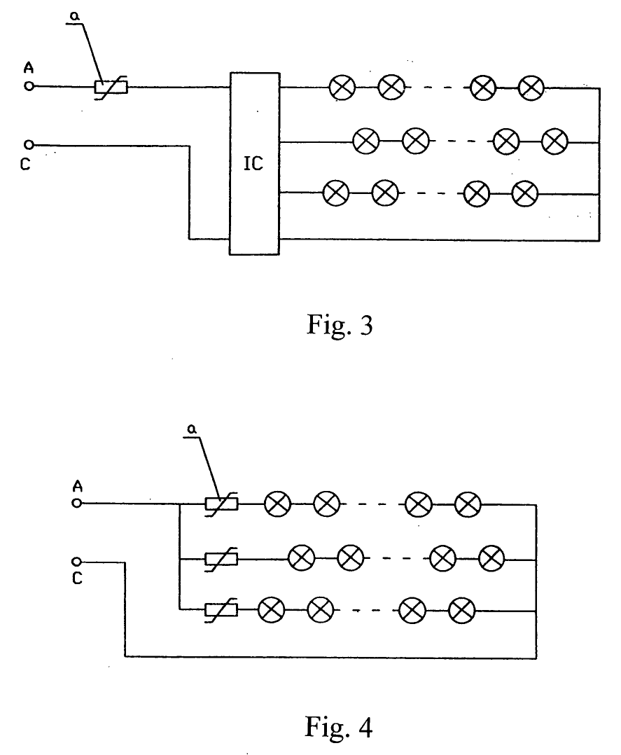

The self-restoring protecting device used in this invention is the self-mending fuse or bimetallic fuse or any other part having the same function. FIG. 1, 2 and 3 show the 3 implementation examples of this invention with the self-mending fuse “a” installed in the main circuit of the decorative lighting. Of course, the self-mending fuse “a” can also be installed in any of the branch circuits of the lighting. The self-mending fuse “a” used in this invention is the PPTC polymer self-mending fuse made of a certain kind of macromolecular material and conductive particles. The working principle of such self-mending fuse can be briefly described as follows. Under normal conditions, the conductive particles form a chain-type conductive passage in the macromolecular material and the fuse remains in the low-resistance state. When overload or short circuit occurs to the circuit, the heat produced by the high current makes the macromolecular material expand promptly, blocking the chain-type conductive passage and the fuse instantly changes from the low-resistance state into high-resistance, breaking the circuit and protecting the load. Upon removal of the trouble, the macromolecular material becomes cold and automatically contracts, which results in enclosure of the conductive passage. The fuse then restores to its initial state. Thus the inventor's objective of repeated use, saving the trouble of replacement and being effective once for all is realized.

What is claimed is:

1. The decorative lighting with the safety protecting device for which the patent is applied for includes the main circuit, a breach circuit connected to the main circuit and the lighting installed in the branch circuit. The decorative lighting features that there is a self-restoring protecting device installed in the circuit.

2. The decorative lighting with the safety protecting circuit as described in claim 1 features that the said self-restoring protecting device is installed in the main circuit of the lighting circuit.

3. The decorative lighting with the safety protecting circuit as described in claim 1 features that the said self-restoring protecting device is installed in the branch circuit of the lighting circuit.

4. The decorative lighting with the safety protecting circuit as described in claim 1 features that the said self-restoring protecting device is a self-mending fuse.

5. The decorative lighting with the safety protecting circuit as described in claim 4 features that the said self-mending fuse is a PPTC polymer self-mending fuse.

6. The decorative lighting with the safety protecting circuit as described in claim 1 features that the said self-restoring protecting device is a bimetallic fuse.

7. The decorative lighting with the safety protecting circuit as described in claim 1 features that the decorative lighting is the Christmas lighting or that for celebrating festivals.

8. The decorative lighting with the safety protecting circuit as described in claim 2 features that the said self-restoring protecting device is a self-mending fuse.

9. The decorative lighting with the safety protecting circuit as described in claim 3 features that the said self-restoring protecting device is a self-mending fuse.

10. The decorative lighting with the safety protecting circuit as described in claim 8 features that the said self-mending fuse is a PPTC polymer self-mending fuse.

11. The decorative lighting with the safety protecting circuit as described in claim 9 features that the said self-mending fuse is a PPTC polymer self-mending fuse.

12. The decorative lighting with the safety protecting circuit as described in claim 2 features that the said self-restoring protecting device is a bimetallic fuse.

13. The decorative lighting with the safety protecting circuit as described in claim 3 features that the said self-restoring protecting device is a bimetallic fuse.
